(19) United States
(12) Patent Application Publication
(10) Pub. No.: US 2017/0206622 A1
(43) Pub. Date: Jul. 20, 2017

(54) SYSTEMS AND METHODS FOR MATCHING DRIVERS WITH PASSENGERS, WHEREIN PASSENGERS SPECIFY THE PRICE TO BE PAID FOR A RIDE BEFORE THE RIDE COMMENCES

(71) Applicant: Indriverru LTD, Nicosia (CY)

(72) Inventors: Aleksandr Pavlov, Yakutsk (RU); ALEKSANDR BURTSEV, Yakutsk (RU); MICHIL ANDROSOV, Yakutsk (RU); MIKHAIL KHARBANOV, Yakutsk (RU)

(21) Appl. No.: 15/371,236

(22) Filed: Dec. 7, 2016

Related U.S. Application Data
(60) Provisional application No. 62/279,835, filed on Jan. 18, 2016.

(51) Int. Cl. G06Q 50/30; G06Q 10/06

(52) U.S. Cl. CPC G06Q 50/30; G06Q 10/063112

(57) ABSTRACT

A computer-implemented method for requesting a ride with a specified fare set by a passenger, the method being performed in connection with a computerized system comprising at least a processor and a memory, the method involving: receiving a ride request from a passenger with a specified fare set by a passenger; transmitting a ride request to the ride requests feed of a driver; selecting a driver in response to the ride request from the passenger with a specified fare by receiving driver requests for an order, determining driver device location, determining driver rating, the driver selection based on his/her location and rating; and providing driver selection results to a passenger, the selected driver and other drivers.

### CROSS-REFERENCE TO RELATED PATENT APPLICATIONS

This regular U.S. patent application is related to, relies upon and claims the benefit of priority from U.S. provisional patent application No. 62/279,835, which is incorporated by reference herein in its entirety.

### BACKGROUND OF THE INVENTION

Technical Field

The disclosed embodiments relate in general to systems and methods for matching drivers with passengers and, more specifically, to systems and methods for matching drivers with passengers, wherein passengers specify the price to be paid for a ride before the ride commences.

Description of the Related Art

Conventionally, in a context of a computerized taxi dispatch service, a cost for the user to order the taxi service is determined by the service itself. The aforesaid user cost is either a fixed price calculated, before the travel commences, according to a predetermined formula, or a metered charge at the end of the trip. In both cases, the passenger is unaware of either the formula used in the cost calculation or the final metered cost of the trip. The infeasibility for the passenger to influence the determination of the travel pricing leads to unreasonably high costs charged for transportation services. This is especially true in a monopolized markets or markets dominated by companies resorting to price fixing or other forms of collusion.

U.S. patent application publication No. 2013268406 (published on Oct. 10, 2013) describes a method for enabling a user to verify a price change for an on-demand service. The method enables determining a real-time price for providing the on-demand service to the user. Specifically, the aforesaid method can help determining when the real-time price is equal to or exceeds a threshold price. In response to a request from the user for the on-demand service when the real-time price is equal to or exceeds the threshold price, an intermediate interface can be provided that the user is to correctly respond to before a service request can be transmitted to a service system.

One of the disadvantages of the above-described solution is the fact that a passenger has no ability to set his or her own price for the trip, which may lead to unreasonably high costs charged for transportation services.

### SUMMARY OF THE INVENTION

The embodiments described herein are directed to systems and methods that substantially obviate one or more of the above and other problems associated with the conventional technology.

In accordance with one aspect of the embodiments described herein, there is provided a computer-implemented method for requesting a ride with a specified fare set by a passenger, the method being performed in connection with a computerized system incorporating at least a processor and a memory, the method involving: receiving a ride request from a passenger with a specified fare set by the passenger; transmitting the ride request to a ride requests feed of a driver; selecting the driver in response to the ride request from the passenger with the specified fare by receiving driver requests for an order, determining a driver device location, determining a driver rating, wherein the driver selection is based on the determined driver device location and the determined driver rating; and providing the driver selection results to the passenger, the selected driver and other drivers.

In accordance with another aspect of the embodiments described herein, there is provided a computerized system for requesting a ride with a specified fare set by a passenger, the computerized system incorporating at least a processor and a memory for: receiving a ride request from a passenger with a specified fare set by the passenger; transmitting the received ride request to an order feed of a driver; receiving a driver request for an order; determining a driver device location; determining a driver rating; selecting a driver based on the determined driver device location and the determine driver rating; and providing the driver selection results to the passenger, the selected driver and other drivers.

In accordance with yet another aspect of the embodiments described herein, there is provided a mobile computing device for requesting a ride with a specified fare set by a passenger, the mobile computing device incorporating a display, a memory and one or more processors for: receiving a ride request from a passenger with a specified fare set by the passenger; transmitting the received ride request to an order feed of a driver; receiving a driver request for an order; determining a driver device location; determining a driver rating; selecting a driver based on the determined driver device location and the determine driver rating; and providing the driver selection results to the passenger, the selected driver and other drivers.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 illustrates an exemplary embodiment of a system for matching drivers with passengers.

FIG. 2 is a block diagram illustrating certain features of a driver selection component according to an exemplary embodiment of the described system.

FIG. 3 illustrates an exemplary embodiment of a user interface of the Order Submission Form with a Fare Input.

FIG. 4 illustrates an exemplary embodiment of a user interface of the Driver Order Feed.

FIG. 5A illustrates an exemplary embodiment of a user interface that is displayed to a driver when the driver attempts to take an order in Awaiting Response State.

FIG. 5B illustrates an exemplary embodiment of a user interface that is displayed to a driver when the driver attempts to take an order in Success State.

FIG. 5C illustrates an exemplary embodiment of a user interface that is displayed to a driver when the driver attempts to take an order in Loss State.

FIG. 6 illustrates an exemplary embodiment of a user interface that is displayed to a passenger while searching for a driver.

FIG. 7 illustrates an exemplary embodiment of a user interface that is displayed to a passenger with a Map of a driver's trip to a passenger.

FIG. 8 illustrates a block diagram that illustrates an embodiment of a computer system upon which various embodiments of the inventive concepts described herein may be implemented.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of a software running on a general purpose computer, in the form of a specialized hardware, or combination of software and hardware.

Exemplary systems and methods are described for matching drivers with passengers, wherein passengers specify the price to be paid for a ride before the ride commences. While passengers are able to set a fare, drivers are free to choose any order they consider as an appropriate one. If there is more than one driver attempting to take the order, the system selects a driver based on parameters such as rating and current location of the driver device.

According to one or more exemplary embodiments, a passenger device 160 can operate an application for requesting ride services. The user interface of the application can provide a user with ability to request a ride and specify a fare of the ride. The currency of the fare can be set based on the country that the user is located in. The passenger also can specify a pickup location and a destination point. The passenger can provide additional information on the request form a user interface feature, such as, for example, special notes for the driver, multiple stopovers if needed or a need in a child seat and/or a minivan before confirming the request. After the passenger requests a ride, the user device can provide the request to the system with necessary user data so that the system can arrange the service between the passenger and a driver.

According to one or more exemplary embodiments, the application on the driver device can provide a user interface, that provides the driver with a list of the passenger ride requests (or an order feed). Each ride request (or an order) can contain detailed information that is provided by a passenger (e.g. a pickup location, a destination, a fare, a distance to the passenger and additional parameters). The driver may take any order he/she considers as an appropriate one.

When the driver selects an order, the driver device can provide a driver request through the driver device interface to the server with necessary driver data.

On the server side, the request receiver component may collect driver requests for a set amount of time for an order. Once time is out, the request receiver stops to receive driver requests and translates collected items to the driver select service. The driver select service may select a driver on the basis of analysis of driver data, such as driver rating and driver location. Depending on the driver selection result, the driver device of the selected driver can provide a transition in the driver user interface to success state or line busy state. The transition can be performed by displaying a graphic that illustrates a seamless transition between the user interfaces.

According to one or more exemplary embodiments, once the ride request has been accepted by the driver, a ride summary user interface can be displayed to a user. The service summary user interface can provide ride request data specified by the passenger and information related to the service for the user so that the user can view details about the driver, for example, a rating and/or feedback for the driver.

As described herein, a “passenger” or a “user” refers to individuals that are requesting or ordering an on-demand service. Also as described herein, a “driver” refer to individuals or entities that can provide the requested service. As an example, a user can request an on-demand service (e.g., Taxi service) using the system, and a service provider can communicate with the system and/or the user to arrange to perform the service. In addition, as described herein, “user devices”, “passenger devices” and “driver devices” refer to computing devices that can correspond to cellular or smartphones, personal digital assistants (PDAs), tablet devices, etc., that can provide network connectivity and processing resources for enabling a user to communicate with a system over a network. A computing device can operate an application for requesting a ride. The application can provide user interface features that provide a user of the application with information for enabling the user to specify a fare.

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Reference throughout this specification to “an implementation” or “one implementation” means that a particular feature, structure, or characteristic described in connection with the implementation is included in at least one implementation. Thus, the appearances of the phrase “an implementation” or “one implementation” in various places throughout this specification are not necessarily all referring to the same implementation. Moreover, it is noted that the “n” notation used in reference to certain elements of the drawings is not intended to be limiting to a particular number of elements. Thus, “n” is to be construed as having one or more of the elements present in a particular implementation. It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

### System Description

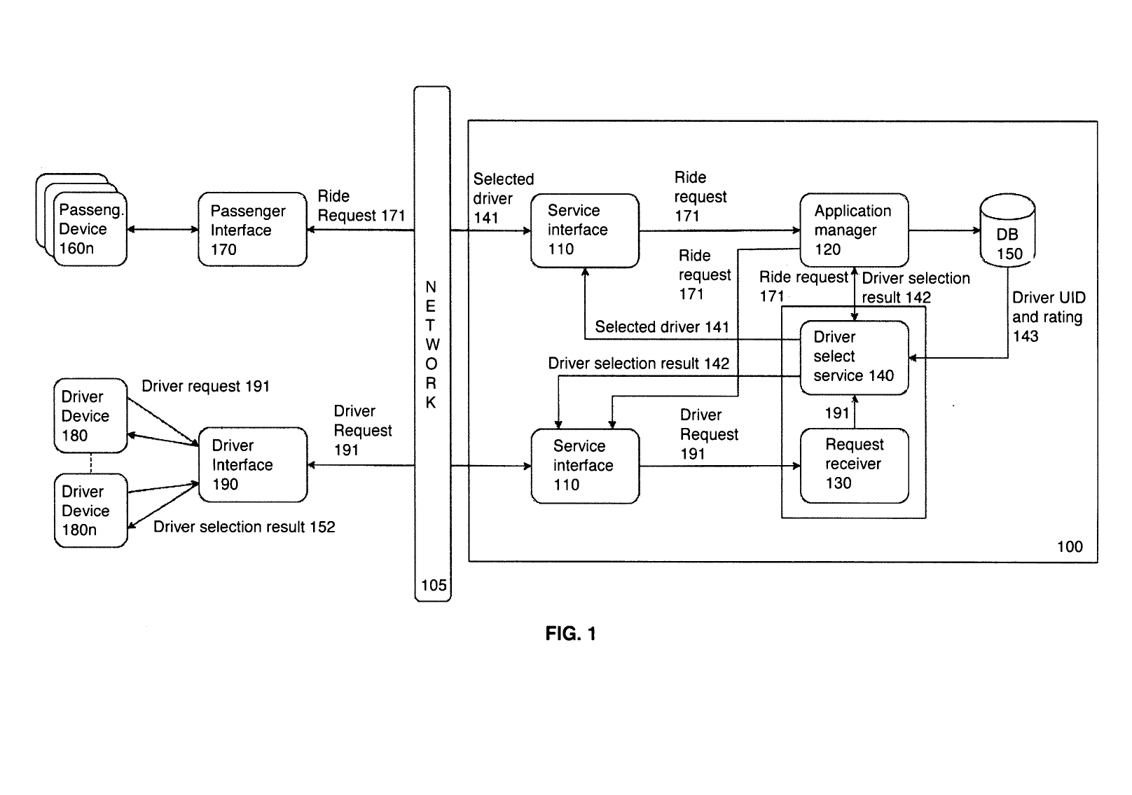

FIG. 1 illustrates an example of a system architecture. The system architecture includes a system 100 and user devices (e.g. both passenger devices 160 and driver devices 180). The user devices may be connected with the system 100 through a passenger interface 170 and/or a driver interface 190. The system 100 may correspond to one or more user devices through a service interface 110. These components may be connected via a network 105, which is described in greater detail below.

The system 100 includes a service interface 110, an application manager 120, a driver select service 140, a request receiver 130 and a database 150. The components of the system 100 can be combined to enable service for matching passengers (users who operate on passenger devices) with drivers (users who operate on driver devices).

A bundle of the passenger interface 170, the driver interface 190 and the service interface 110 provides communications between the system 100 and user devices (e.g. passenger devices 160 and driver devices 180) over the network 105. Each of the passenger devices can download, store and operate an application that can interact with the service interface 110 through the passenger interface in order to provide information to and/or receive information from the service interface 110. Similarly, drivers can operate their driver devices 180 to download, store and operate the same application that also can interact with the service interface 110 through the driver interface 190.

The service interface 110 can receive ride request data 171 from one or more passenger devices 160 and/or driver request data 191 from one or more driver devices 180 over the network 105. For example, data can be received from a user device when a user launches or operates the application (or performs other actions in the application).

According to one or more exemplary embodiments, ride request data 171 can include data indicating a GPS location of the passenger device, a user ID data, a fare set by the passenger and ride request details (e.g. pickup location, destination and additional information).

The service interface 110 receives ride request data 171, handles the data, processes the data to translate it to the application manager 120. Because the service interface 110 can receive a large amount of data from the user devices (e.g. passenger devices 160 and driver devices 180), the application manager 120 handles and organizes the ride request data 171 for storage in one or more databases 150. For example, the data can be deleted, categorized into tables, etc. so that components of system 100 can easily access the data from the databases to retrieve necessary information. The application manager 120 also translates the list of ride requests to the driver devices 180 via the service manager 110.

According to one or more exemplary embodiments, driver requests 191 can include data indicating a gps location of the driver device, a user ID data and a ride request id which the driver has selected. When the data is received over the network 105, the service interface 110 can provide the received driver request to the request receiver 130.

The service interface 110 receives driver request data 191, handles the data, processes the data to translate it to the request receiver 130. The request receiver 130 component can collect driver requests for a set amount of time for an order. For example, in some implementations, when the request receiver receives first driver request from a driver on the order, the timer starts countdown to receive additional driver requests. Depending on implementation, the amount of time can vary and can be set as a parameter. Once time is out, the request receiver 130 stops to receive driver requests and translates collected items to the driver select service 140.

The driver select service 140 may select a driver on the basis of analysis of driver data, such as driver rating and driver location. For example, in some cases the request receiver can process a large amount of driver requests 191 received for each of the ride requests 171. The driver select service 140 processes the selection of drivers by driver locations, which is included in the driver request 191, and driver rating 143, which is stored in the database 150. The closest driver with appropriate rating can be assigned to the order, while other drivers can be informed that the order is taken through the service interface 110. The driver select service 140 can change a status of the driver request 191. In another case, there can be a single driver request 191 from a single driver device 121, which is assigned to the order automatically due to no competition.

The driver select service 140 can then provide driver selection results 142 to the service interface 110 and the application manager 120. The service interface 110 can transmit the driver selection result 142 to the driver devices 180 over the network 105. The driver service interface can also provide the selected driver data 141 to the passenger devices 160, so that the passenger can be notified about the arrangement.

The driver select service 140 can provide data to the application manager 120 that include information about the user IDs of the requesting driver devices 180, the current time, the current location of the driver devices 180 and the statuses of the driver requests 191 (e.g. the status of the driver request 191 of the assigned driver and the status of the driver request 191 which is not selected). The application manager 120 handles and organizes provided data for storage in one or more databases 150.

The network 105 may include a public network (e.g., the Internet), a private network (e.g., a local area network (LAN) or a wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

### Method Description

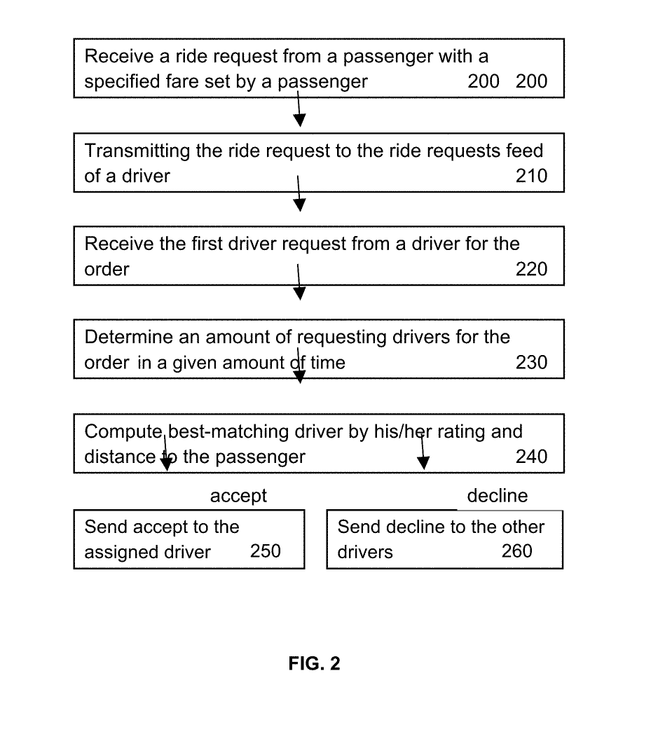

FIG. 2 illustrates an example method for requesting a ride with a specified fare set by a passenger comprising receiving a ride request from a passenger with a specified fare set by a passenger, transmitting a ride request to the ride requests feed of a driver and matching drivers with passengers based on received data, according to an implementation. A method described here can be implemented using components described in system description of FIG. 1. The service interface 110 receives ride request data 171 from one or more passenger devices 160.

According to one or more exemplary embodiments, ride request data 171 can include data indicating a GPS location of the passenger device, a user ID data, a fare set by the passenger and ride request details (e.g. pickup location, destination and additional information) (step 200).

According to one or more exemplary embodiments, the service interface 110 receives ride request data 171, handles the data, processes the data to translate it to the application manager 120. The application manager 120 also translates the list of ride requests to the driver devices 180 via the service manager 110 (step 210).

According to one or more exemplary embodiments, the request receiver 130 receives a driver request 191 from a driver for the order with driver request data, e.g. a current location, a driver UID, an order ID, etc. When the request receiver receives a first driver request from a driver (step 220) on the order, the timer starts countdown to receive additional driver requests (step 230). Depending on implementation, the amount of time can vary and can be set as a parameter. For example, the timer is set to five seconds, when the first driver request is received on an order, the timer starts countdown. Within five seconds the request receiver 130 component collects driver requests from drivers. Once countdown has stopped, the order is being removed from the order feed, so no one else could try to take the order.

According to one or more exemplary embodiments, once the number of driver requests is determined, the request receiver sends collected driver requests to the driver select service to compute a best-matching driver (step 240). According to an implementation, a driver can be assigned to the order based on the driver's current distance from a passenger and his/her rating. For example, in some variations, a driver with 60 rating and 500 meters away from the passenger will be selected over a driver with the rating of 65 and 1 km far from the passenger. If there's no more than only one driver request, then the order will be taken by the only requester.

According to one or more exemplary embodiments, the selection results are provided to the passenger devices and the driver devices. The passengers and drivers can be notified on the driver selection results. Once the best-matching driver is selected, the driver select service 140 can send “accept” status to the assigned driver, while the other requesting drivers receive “decline” status. The applications that are running on the passenger devices can use data of the driver selection result in order to provide a user interface that displays the assigned driver information, while the applications on the driver devices can display the user interface of the driver attempting to take an order in success state or line busy state according to the driver selection results.

### User Interface Description

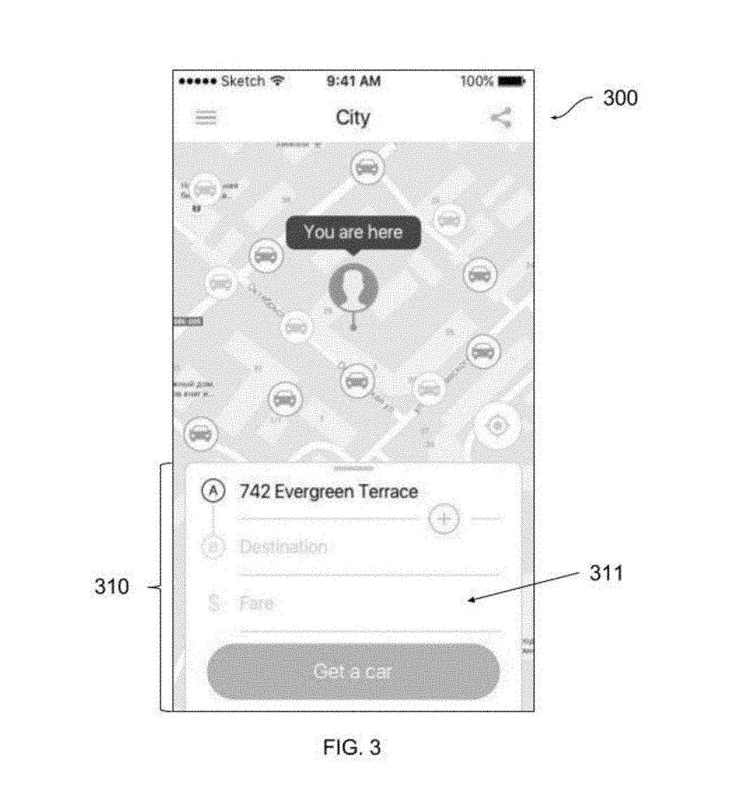

FIG. 3 illustrates an exemplary embodiment of a user interface of the order submission form that is displayed to a passenger who requests a ride. The user interface 300 illustrates a user interface that can be provided by an application running on a user device. Such an application can be provided by an entity that enables a service to be arranged between drivers and passengers and also allows specifying a fare of the ride. For example, a user can download and install the application on his/her device, and register the device with system 100. The user can also create an account to be able to request services (e.g. provide a user name, a date of birth, etc.). The stored application can enable data to be exchanged between the application and the system 100, so that the user can interact with the system 100.

According to one or more exemplary embodiments, when a user launches the application and operates the service application, a variety of different user interfaces can be provided on the display of the device depending on different stages or steps during the ride request process. For example, the service application can first display a sign in a user interface where a user must first enter in his/her phone number in order to log in to the application and to be able to interact with the system 100. After signing in, the application can display a user interface 300 that illustrates the order submission form 310.

According to one or more exemplary embodiments, a fare for the ride can be set by a passenger, e.g., the passenger can decide how much money he/she can spend on the ride. The order submission form can consist of inputs of a pickup location, a destination location, a fare 311, additional information for a driver. Depending on implementations, when a user interacts with the form, the form can be expanded so that the user can specify multiple stopovers and/or request additional options such as a need in a child seat and/or a minivan. By submitting the order submission form, the user can request a ride. Then the application transmits the ride request to the system 100 for processing.

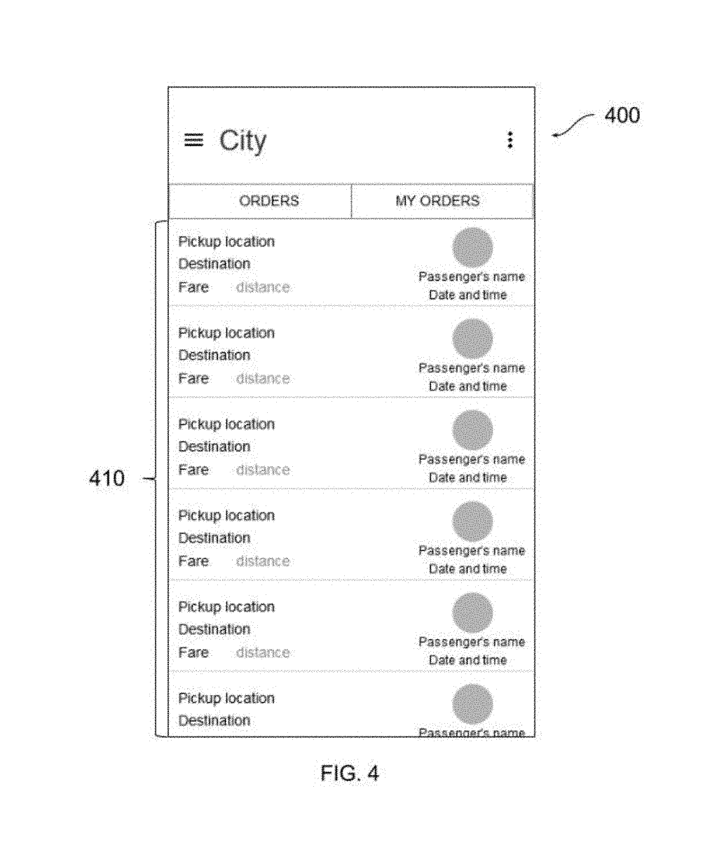

FIG. 4 illustrates an example of a user interface 400 of the driver order feed 410 (or the ride request feed) that is displayed to a driver that seeks for an order. Each ride request 171 falls into an order feed of the driver devices. The order feed can display orders in chronological order, e.g., from newest to the latest available ride requests. Depending on implementation, the application can provide a user interface displaying only near orders so that it can be fulfilled in decent time.

According to one or more exemplary embodiments, each ride request 171 that is displayed to the driver is selectable. The application that provides the user interface 400 can use the ride request data (e.g., the ride request data 171 provided by the system 100) to display the order feed 410. For example, the order can include a fare specified by the passenger, a pickup location, a destination location, etc. In some examples, it also can include additional information such as a need in a child seat, a minivan, stopovers. The order feed interface can also provide information about a distance to the passenger in meters (kilometers or another metric system), a passenger's user details (e.g. a user name and a user photo) and time when the ride request has been submitted.

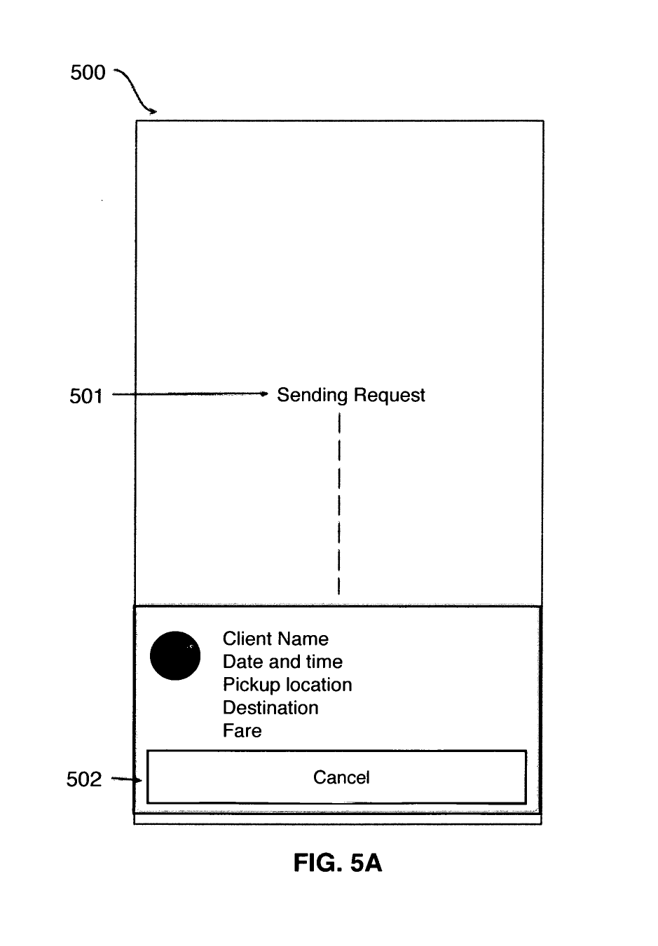

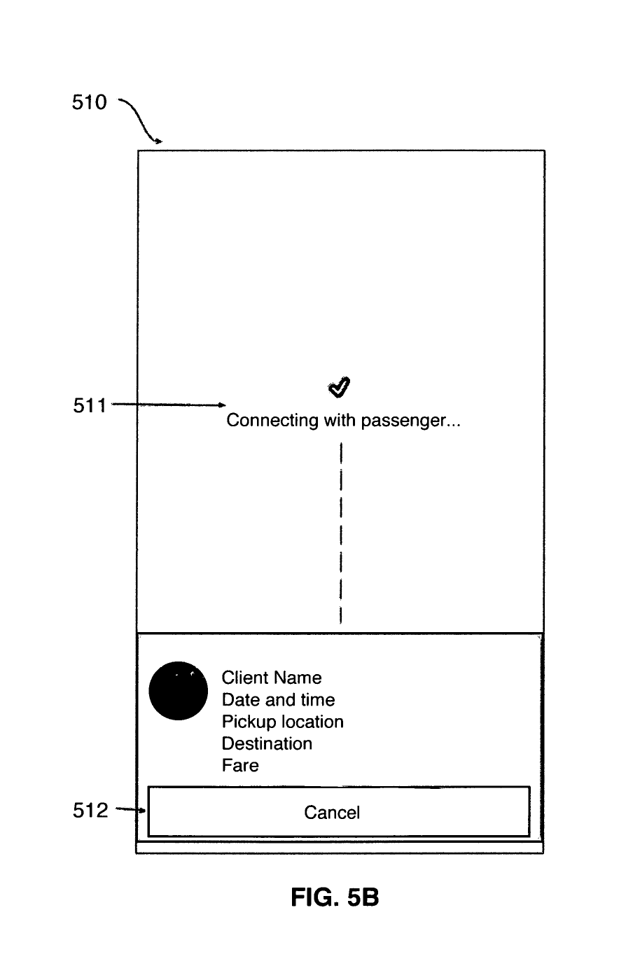

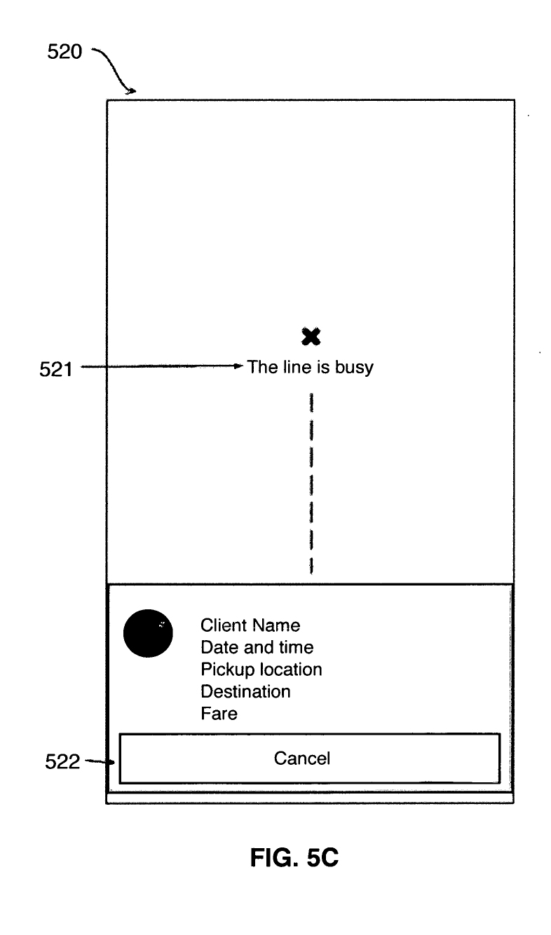

FIG. 5A, 5B and 5C illustrate an example series of user interfaces that is displayed to a driver that attempts to take an order. The user interfaces 500, 510, 520 illustrate various user interfaces that can be provided by the application running on the driver device. Such series of user interfaces can be displayed to the driver who intends to take an order.

According to one or more exemplary embodiments, when the order is selected in the order feed 410, the application can provide a transition in the user interface of the driver device to display the awaiting response state 500. The element 501 indicates driver request processing, while the request receiver 130 collects driver requests until the time is up. The cancel button 502 is available to prevent accidental order taking.

According to one or more exemplary embodiments, when the system 100 assigns the order to the driver, the system 100 can notify the assigned driver so that the application can provide a transition in a user interface from the awaiting state 500 to the success state 510. The element 501 changes its state 511 as shown in FIG. 5B. The cancel button 512 becomes inactive as it's not allowed to cancel in this state.

According to one or more exemplary embodiments, the system 100 sends notifications with the driver selection results to the other drivers who made a driver request 191 to the order. The application can provide a transition in a user interface from the awaiting state 500 to the line busy state 520. The element 501 changes its state 521 as shown in FIG. 5C. If that happens, after this state the driver is returned to the order feed interface 400. The cancel button 522 becomes inactive as it's not allowed to cancel in this state.

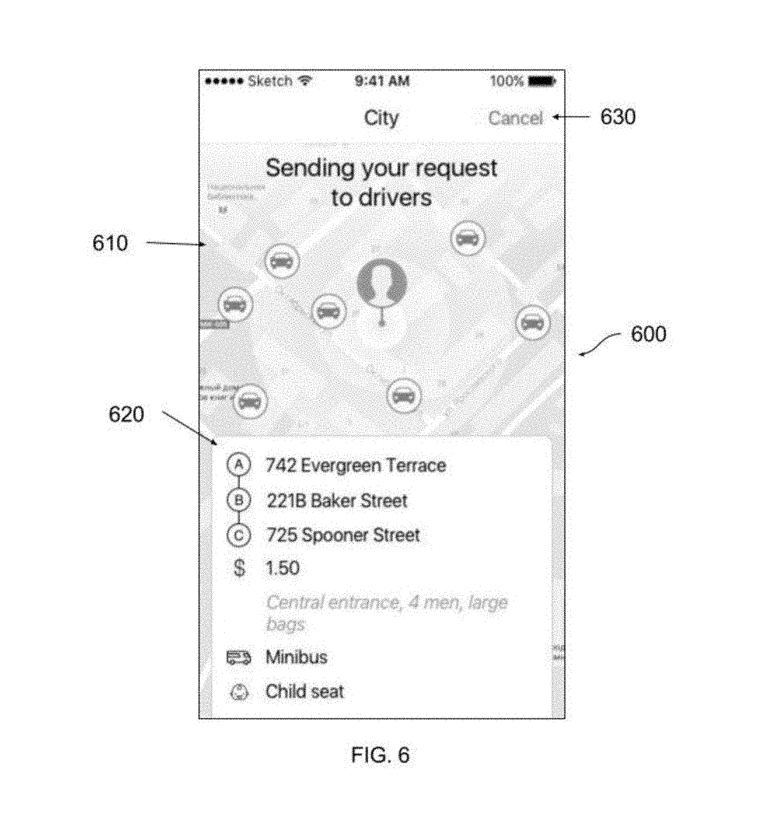

FIG. 6 illustrates an example of a user Interface that is displayed to the passenger while searching for a driver and is a sequel to FIG. 1 after the passenger submits the order. The passenger device provides a change in the interface to the searching for a driver state 600.

According to one or more exemplary embodiments, the user interface in state 600 can include a map with a radar 610 symbolizing a driver searching process and passenger-provided ride request data 620. The cancel button 630 is also available for the passenger to cancel the searching.

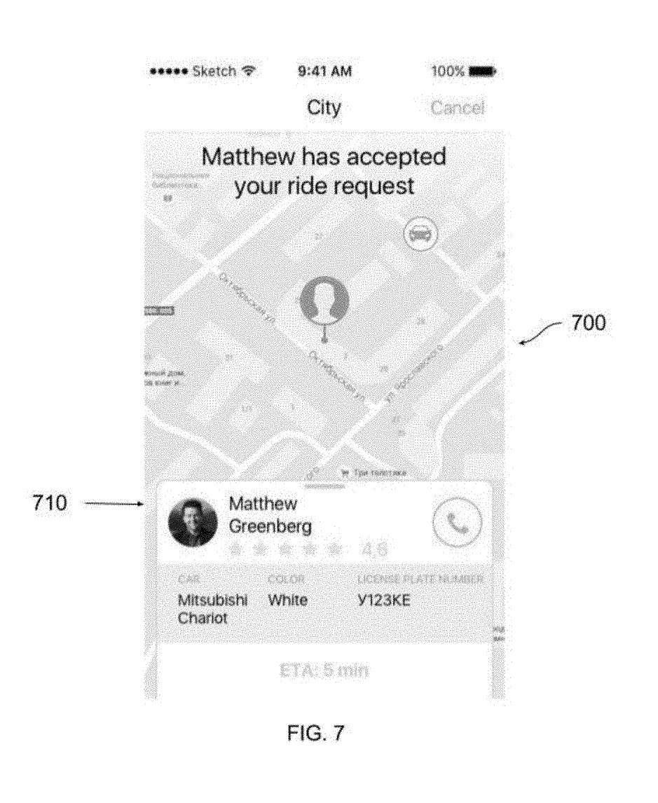

FIG. 7 illustrates an example of user Interface 700 that is displayed to a passenger when a driver is assigned to the order. When the assigned driver 141 (in FIG. 1) is determined, the application can provide a transition in the user interface from the state 600 (FIG. 6) to the state 700. The user interface can provide information about the assigned driver 710 to help the passenger to identify the driver.

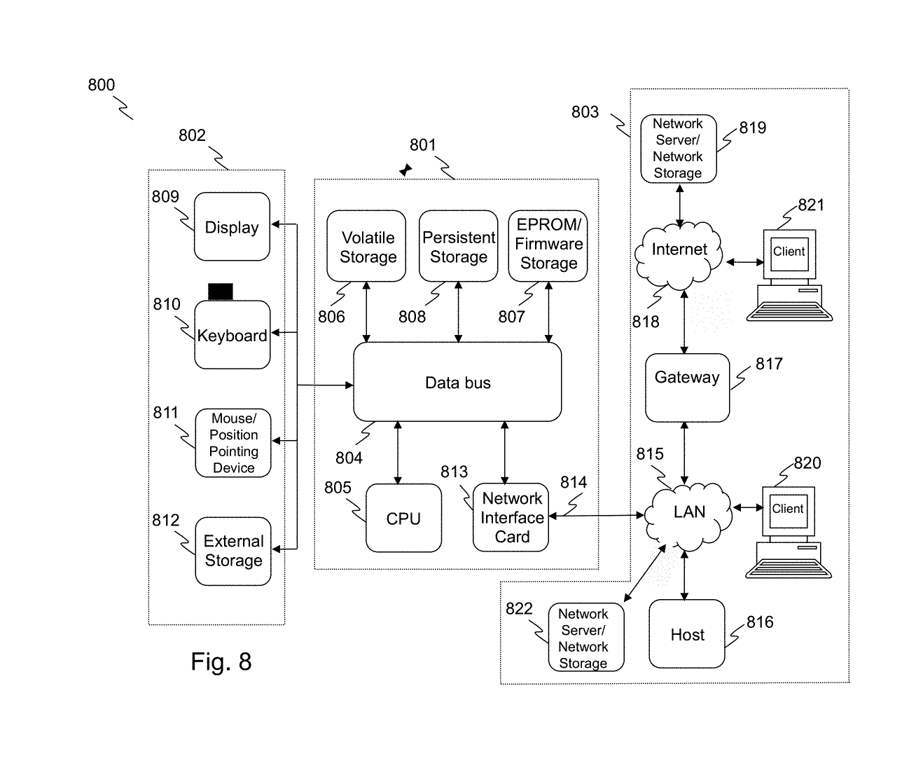

FIG. 8 is a block diagram that illustrates an embodiment of a computer system 800 upon which various embodiments of the inventive concepts described herein may be implemented. The system 800 includes a computer platform 801, peripheral devices 802 and network resources 803.

The computer platform 801 may include a data bus 804 or other communication mechanism for communicating information across and among various parts of the computer platform 801, and a processor 805 coupled with bus 804 for processing information and performing other computational and control tasks. Computer platform 801 also includes a volatile storage 806, such as a random access memory (RAM) or other dynamic storage device, coupled to bus 804 for storing various information as well as instructions to be executed by processor 805, including the software application for proxy detection described above. The volatile storage 806 also may be used for storing temporary variables or other intermediate information during execution of instructions by processor 805. Computer platform 801 may further include a read only memory (ROM or EPROM) 807 or other static storage device coupled to bus 804 for storing static information and instructions for processor 805, such as basic input-output system (BIOS), as well as various system configuration parameters. A persistent storage device 808, such as a magnetic disk, optical disk, or solid-state flash memory device is provided and coupled to bus 804 for storing information and instructions.

Computer platform 801 may be coupled via bus 804 to a touch-sensitive display 809, such as a cathode ray tube (CRT), plasma display, or a liquid crystal display (LCD), for displaying information to a system administrator or user of the computer platform 801. An input device 810, including alphanumeric and other keys, is coupled to bus 804 for communicating information and command selections to processor 805. Another type of user input device is cursor control device 811, such as a mouse, a trackball, or cursor direction keys for communicating direction information and command selections to processor 805 and for controlling cursor movement on touch-sensitive display 809. This input device typically has two degrees of freedom in two axes, a first axis (e.g., x) and a second axis (e.g., y), that allows the device to specify positions in a plane. To detect user's gestures, the display 809 may incorporate a touchscreen interface configured to detect user's tactile events and send information on the detected events to the processor 805 via the bus 804.

An external storage device 812 may be coupled to the computer platform 801 via bus 804 to provide an extra or removable storage capacity for the computer platform 801. In an embodiment of the computer system 800, the external removable storage device 812 may be used to facilitate exchange of data with other computer systems.

The invention is related to the use of computer system 800 for implementing the techniques described herein. In an embodiment, the inventive system may reside on a machine such as computer platform 801. According to one embodiment of the invention, the techniques described herein are performed by computer system 800 in response to processor 805 executing one or more sequences of one or more instructions contained in the volatile memory 806. Such instructions may be read into volatile memory 806 from another computer-readable medium, such as persistent storage device 808. Execution of the sequences of instructions contained in the volatile memory 806 causes processor 805 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 805 for execution. The computer-readable medium is just one example of a machine-readable medium, which may carry instructions for implementing any of the methods and/or techniques described herein. Such a medium may take many forms, including but not limited to, non-volatile media and volatile media. Non-volatile media includes, for example, optical or magnetic disks, such as the persistent storage device 808. Volatile media includes dynamic memory, such as volatile storage 806.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, or any other medium from which a computer can read.

Various forms of computer readable media may be involved in carrying one or more sequences of one or more instructions to processor 805 for execution. For example, the instructions may initially be carried on a magnetic disk from a remote computer. Alternatively, a remote computer can load the instructions into its dynamic memory and send the instructions over a telephone line using a modem. A modem local to computer system can receive the data on the telephone line and use an infra-red transmitter to convert the data to an infra-red signal. An infra-red detector can receive the data carried in the infra-red signal and appropriate circuitry can place the data on the data bus 804. The bus 804 carries the data to the volatile storage 806, from which processor 805 retrieves and executes the instructions. The instructions received by the volatile memory 806 may optionally be stored on persistent storage device 808 either before or after execution by processor 805. The instructions may also be downloaded into the computer platform 801 via Internet using a variety of network data communication protocols well known in the art.

The computer platform 801 also includes a communication interface, such as network interface card 813 coupled to the data bus 804. Communication interface 813 provides a two-way data communication coupling to a network link 814 that is coupled to a local network 815. For example, communication interface 813 may be an integrated services digital network (ISDN) card or a modem to provide a data communication connection to a corresponding type of telephone line. As another example, communication interface 813 may be a local area network interface card (LAN NIC) to provide a data communication connection to a compatible LAN. Wireless links, such as well-known 802.11a, 802.11b, 802.11g and Bluetooth may also used for network implementation. In any such implementation, communication interface 813 sends and receives electrical, electromagnetic or optical signals that carry digital data streams representing various types of information.

Network link 814 typically provides data communication through one or more networks to other network resources. For example, network link 814 may provide a connection through local network 815 to a host computer 816, or a network storage/server 822. Additionally or alternatively, the network link 814 may connect through gateway/firewall 817 to the wide-area or global network 818, such as an Internet. Thus, the computer platform 801 can access network resources located anywhere on the Internet 818, such as a remote network storage/server 819. On the other hand, the computer platform 801 may also be accessed by clients located anywhere on the local area network 815 and/or the Internet 818. The network clients 820 and 821 may themselves be implemented based on the computer platform similar to the platform 801.

Local network 815 and the Internet 818 both use electrical, electromagnetic or optical signals that carry digital data streams. The signals through the various networks and the signals on network link 814 and through communication interface 813, which carry the digital data to and from computer platform 801, are exemplary forms of carrier waves transporting the information.

Computer platform 801 can send messages and receive data, including program code, through the variety of network(s) including Internet 818 and LAN 815, network link 815 and communication interface 813. In the Internet example, when the system 801 acts as a network server, it might transmit a requested code or data for an application program running on client(s) 820 and/or 821 through the Internet 818, gateway/firewall 817, local area network 815 and communication interface 813. Similarly, it may receive code from other network resources.

The received code may be executed by processor 805 as it is received, and/or stored in persistent or volatile storage devices 808 and 806, respectively, or other non-volatile storage for later execution.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, Objective-C, perl, shell, PHP, Java, as well as any now known or later developed programming or scripting language.

Moreover, other implementations of the invention will be apparent to those skilled in the art from consideration of the specification and practice of the invention disclosed herein. Various aspects and/or components of the described embodiments may be used singly or in any combination in the systems and methods for matching drivers with passengers. It is intended that the specification and examples be considered as exemplary only, with a true scope and spirit of the invention being indicated by the following claims.

What is claimed is:

1. A computer-implemented method for requesting a ride with a specified fare set by a passenger, the method being performed in connection with a computerized system comprising at least a processor and a memory, the method comprising:
a. receiving a ride request from a passenger, the ride request comprising a fare set by the passenger;
b. transmitting the ride request to a ride requests feed of a driver;
c. selecting the driver in response to the ride request from the passenger with the specified fare by receiving driver requests for an order, determining a driver device location, determining a driver rating, wherein the driver selection is based on the determined driver device location and the determined driver rating; and
d. providing the driver selection results to the passenger and the driver.

2. The computer-implemented method of claim 1, wherein the ride request from the passenger is received using a graphical user interface generated on a mobile computing device of the passenger.

3. The computer-implemented method of claim 1, wherein the ride request from the passenger comprises destination information.

4. The computer-implemented method of claim 1, wherein the ride request from the passenger comprises information on two or more destinations.

5. The computer-implemented method of claim 1, wherein the ride request from the passenger comprises one or more options requested by the passenger.

6. The computer-implemented method of claim 1, further comprising providing the driver selection results to other drivers.

7. The computer-implemented method of claim 6, wherein the driver selection results provided to other drivers comprise information that the other drivers have not been selected.

8. A computerized system for requesting a ride with a specified fare set by a passenger, the computerized system comprising at least a processor and a memory for:
a. receiving a ride request from a passenger comprising a specified fare set by the passenger;
b. transmitting the received ride request to an order feed of a driver;
c. receiving a driver request for an order;
d. determining a driver device location;
e. determining a driver rating;
f. selecting a driver based on the determined driver device location and the determine driver rating; and
g. providing the driver selection results to the passenger and the driver.

9. The computer-implemented method of claim 8, wherein the ride request from the passenger is received using a graphical user interface generated on a mobile computing device of the passenger.

10. The computer-implemented method of claim 8, wherein the ride request from the passenger comprises destination information.

11. The computer-implemented method of claim 8, wherein the ride request from the passenger comprises information on two or more destinations.

12. The computer-implemented method of claim 8, wherein the ride request from the passenger comprises one or more options requested by the passenger.

13. The computer-implemented method of claim 8, further comprising providing the driver selection results to other drivers.

14. The computer-implemented method of claim 13, wherein the driver selection results provided to other drivers comprise information that the other drivers have not been selected.

15. A mobile computing device for requesting a ride with a specified fare set by a passenger, the mobile computing device comprising a display, a memory and one or more processors for:
a. receiving a ride request from a passenger with a specified fare set by the passenger;
b. transmitting the received ride request to an order feed of a driver;
c. receiving a driver request for an order;
d. determining a driver device location;
e. determining a driver rating;
f. selecting a driver based on the determined driver device location and the determine driver rating; and
g. providing the driver selection results to the passenger and other drivers.

16. The computer-implemented method of claim 15, wherein the ride request from the passenger is received using a graphical user interface generated on the mobile computing device.

17. The computer-implemented method of claim 15, wherein the ride request from the passenger comprises destination information.

18. The computer-implemented method of claim 15, wherein the ride request from the passenger comprises information on two or more destinations.

19. The computer-implemented method of claim 15, wherein the ride request from the passenger comprises one or more options requested by the passenger.

20. The computer-implemented method of claim 15, further comprising providing the driver selection results to other drivers.
